(19) United States
(12) Patent Application Publication
(10) Pub. No.: US 2016/0006254 A1
(43) Pub. Date: Jan. 7, 2016

(54) Serial Hybrid Microgrid with PPSA-mediated interface to Genset and to Non-Dispatchable Power

(71) Applicant: Ideal Power Inc., Austin, TX (US)

(72) Inventor: Paul Bundschuh, Austin, TX (US)

(21) Appl. No.: 14/746,833

(22) Filed: Jun. 22, 2015

Related U.S. Application Data
(60) Provisional application No. 62/015,096, filed on Jun. 20, 2014.

(51) Int. Cl. H02J 3/46; H02J 3/38

(52) U.S. Cl. CPC H02J 3/46; H02J 3/383; H02J 3/386; H02J 2003/388

(57) ABSTRACT

A microgrid system in which power from a non-dispatchable energy source and power from a combustion-powered backup generator are both connected to the microgrid and its loads through a Power Packet Switching Architecture (PPSA) power converter. The converter provides voltage management and synchronization for both the backup generator power and also for the non-dispatchable power.

### CROSS-REFERENCE

Priority is claimed from U.S. provisional application 62/015,096, filed 20 Jun. 2014, which is hereby incorporated by reference.

### BACKGROUND

The present application relates to backup electrical power supplies, and more particularly to microgrids which include a combustion-driven generator set (genset) as well as a grid disconnect, and still more specifically to microgrids which can also make use of a non-dispatchable power source, such as wind, solar, tidal or hydroelectric power.

Note that the points discussed below may reflect the hindsight gained from the disclosed inventions, and are not necessarily admitted to be prior art.

Backup Power

Backup power supply is a continuing need wherever electrical loads are powered from a grid, and also in remote locations where grid power is unavailable. In many cases the most convenient way to supply backup power is with a generator driven by a combustion engine. This may be an internal combustion engine (for power ratings from a few kilowatts to a few megawatts), or a gas turbine engine at higher powers.

Backup power is particularly important for critical loads in locations such as hospitals. In many cases some of the load can be shed without dire consequences, even if some fraction of the electrical load is critical. In a hospital, for example, laundry operations can be paused if needed. In an industrial installation, firefighting may be a critical load.

Non-Dispatchable Power

Combustion-driven generation necessarily emits combustion products, which are a problematic source of pollution in many locations. “Green” sources of power avoid this, and are often available at relatively low cost. Green energy sources include hydroelectric power, wind power, and solar (photovoltaic) power, among others. However, many green energy sources are not dispatchable: solar and wind power, for example, are both subject to the vagaries of weather. Hydroelectric power too can have weather-induced variation over longer time scales, and is not dispatchable in locations which do not have controlled release from a reservoir. Other non-dispatchable sources, such as cogeneration from waste process heat, or trigeneration using waste heat from coal-fired or nuclear generation, would not necessarily be described as green energy, but still represent useful localized sources of low-cost power.

Combustion-driven generation is dispatchable, but is dependent on proper functioning of the combustion engine. It is therefore common to exercise a combustion-driven genset weekly or monthly, to assure its availability when needed.

If a combustion-driven generator is connected to the power grid, phase differences will be important. (The phase of a combustion-driven engine at startup is unpredictable.) An old way to match the phase of a genset to the grid, or to other gensets, is to start the combustion engine, bring it up to governed speed, adjust the physical phase of the motor-generator combination by braking the engine slightly until the AC voltage between corresponding terminals is relatively small (e.g. a few Volts), and then connecting the corresponding terminals together. This process is then repeated to synchronize multiple gensets together.

However, the above process is completely unsuited for modern microgrid configurations. Especially where a microgrid includes multiple power sources, or a grid tie, or where multiple microgrids may need to be connected together, some way to synchronize phase without human intervention is needed.

Backup genset power is a fairly challenging application for internal combustion engines, since the duty cycle is so low. If the engine is not operated for long enough when exercised, the oil chemistry can be altered by combustion byproducts, and deposits can accumulate more quickly (per hour of operation) than they would at full load.

There are many ways to optimize engine operation, as is well known to mechanical engineers within the subspecialties of internal combustion engine operation. For example, an engine can be programmed to operate at maximum fuel efficiency per kilowatt-hour, maximum torque, peak power (e.g. the maximum power it can sustain for 10 minutes), or rated power at 100% duty cycle.

Larger internal combustion engines often operate at slower speeds. To give extreme examples, the large low-speed diesel engines used for marine propulsion often have a shaft speed of 120 rpm or less, whereas small motorcycle-racing engines may operate at 20,000 rpm. In gensets, the generator will commonly have multiple poles, so that it can operate at a fraction of the power-line frequency; for example, in countries with 60 Hz power standards, generators are often designed to operate at 900 or 1200 rpm.

However, not all countries use a 60 Hz power line frequency: many countries use a 50 Hz standard. To use a genset which has been optimized for 60 Hz operation, the operating speed of the engine can be lowered by 16%; but the result of this is lower power, and sometimes lower efficiency, at the same cost.

The present application teaches new ways to operate power sources for microgrids. Preferably a PPSA is used to transfer power to a microgrid from both a combustion-powered generator and one or more non-dispatchable power sources, and preferably also provides bidirectional transfer of power to and from a battery bank.

Other commonly owned applications have suggested that a PPSA power converter can be used to provide synchronization to grid for unsynchronized generation unit: see e.g. U.S. application No. 61/783,731 (IPC-218), Ser. No. 14/182,268 (IPC-129), and/or Ser. No. 14/183,289 (IPC-154), which are all hereby incorporated by reference. The present application teaches that a PPSA-type power converter can be used to interface not only to a non-dispatchable energy source (such as wind or solar), but also to a combustion-fired backup generator set and to an energy storage unit (such as a battery bank). The PPSA's power conversion and synchronization functions are used not only for an interface to the non-dispatchable energy sources (and preferably to the battery bank), but also provide the interface to the combustion genset. A surprising aspect of this is that—as long as the voltage limits of the power converter are not breached—the combustion genset can be operated for best efficiency and/or lifetime, without any consideration for the frequency or voltage required by the loads on the microgrid.

A further point is that excitation can also be controlled independently of any of the load requirements. The voltage output of large gensets is often controlled by adjusting the excitation of the generator. However, in the architecture disclosed here, the excitation can be optimized, e.g. for best net efficiency of the generator head, without considering the voltage which the genset provides to the PPSA converter.

Note that, since operation of the genset engine is independent of the demands of the load elements (except for gross power demand), additional optimizations can be performed to get the ultimate maximization of efficiency, or air quality, or even of power. For example, maximum power output will be sensitive to ambient temperature, pressure, and humidity.

Many optimizations are possible, but perhaps the clearest distinction is what is not constrained: the rotational speed of the genset is allowed to vary (at least within a range much broader than allowed conventionally, e.g. +/−1% or more, possibly +/−10% or more). Rotational speed is of course related to other parameters of operation, but the optimal rotational speed is a byproduct of the optimization, and not the target.

A second important distinction is that the output voltage of the genset is not constrained (except possibly within a broad range, e.g. +/−20%). Here too, the genset voltage is a result of optimization, and not a constraint nor a target.

Most preferably, the generator size is reduced since it only supports average loads, not peak loads. This requires that the battery bank be sized large enough to support more than the additional draw of peak loads for a duration which is more than the typical time of peak load draw.

In one particularly preferred class of embodiments, the non-dispatchable power is DC with a predetermined polarity, so that one port of the PPSA converter can be shared between the non-dispatchable power and the battery bank.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 schematically shows a microgrid implementing various disclosed inventions.

FIG. 2 shows another example of a microgrid which includes connections through a PPSA converter to a non-dispatchable energy source, as well as to a combustion genset and a battery bank.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

Microgrids are increasingly recognized as a solution to improve grid-resiliency from power grid failures as well as to support increasing amounts of renewable energy such as solar and wind.

Emergency power generation systems often use asynchronous AC combustion generators using diesel fuel to provide power directly to critical loads without power conversion, but suffer from several limitations. Since they cannot synchronize to the power grid, they are unable to operate when connected to an active power grid, which limits their ability to provide grid benefits such as peak demand reduction. These asynchronous AC generators do not operate at optimal efficiency as they are sized above peak power requirements for critical loads, while for optimum efficiency they should be sized closer to average loads. They also have high fuel and maintenance costs, and create Green House Gas (GHG) and other emissions. These AC generators normally have poor power quality and are difficult to network together to support larger systems.

A serial hybrid microgrid with PPSA power converter addresses these limitations of conventional microgrids using conventional asynchronous diesel generators. This approach will become more attractive to industry as the cost and efficiency of power conversion system improves, as also a higher percentage of the energy is provided from renewable energy or battery resources.

### Example with 4-port Converter

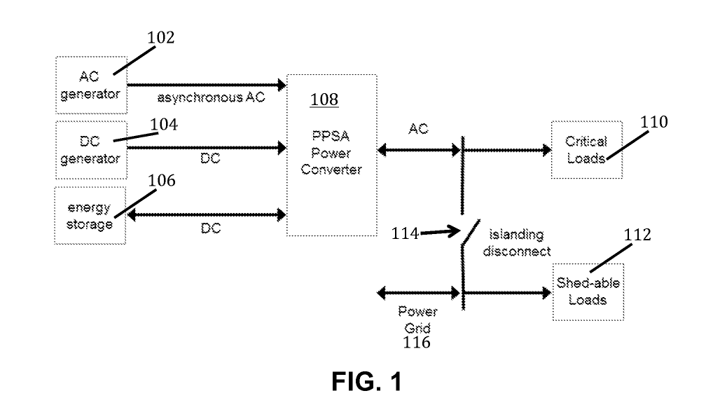

FIG. 1 shows a sample implementation. A grid connection 116 supplies sheddable loads 112, and is also routed through an islanding disconnect switch 114 to supply the microgrid which includes the critical loads 110. Also connected to this microgrid is a power-packet-switching converter 108, such as that described in U.S. Pat. No. 8,391,033, which is hereby incorporated by reference.

The converter 108, in this example, is a four-port converter. One port is connected to the grid. A second port is connected to an asynchronous AC genset 102 (e.g. diesel-powered). A third port is connected to a DC energy storage unit 106, which can be e.g. a bank of batteries. A fourth port is connected to a non-dispatchable power source 104, which can be solar energy (and is therefore shown as DC here). (However, in other implementations this can use other sources, such as wind or hydroelectric power or cogeneration using waste heat, which are not necessarily DC.)

In FIG. 1 power transfer between the converter 108 and energy storage 106 is shown as bidirectional, as is power transfer between the converter 108 and the microgrid. Preferably each of the four ports allows bidirectional transfer, but this is not strictly necessary.

Operation

When the grid power goes down (or goes out of limits), islanding disconnect switch 114 opens. The resulting microgrid includes the critical loads 110, and is now supplied from the PPSA converter 108.

The operation of converter 108 can be programmed however desired. In one example, power is drawn from the DC generator 104 (e.g. a PV array) if enough output is available to meet the demands of the critical loads 110, and any transient shortfall is supplied from the energy storage unit 106. If the power from energy storage 106 and from DC generator 104 is expected to be insufficient within less than some specified time—e.g. 5 minutes or 2 hours—the AC generator 102 is started up. Note that the AC generator 102 is preferably operated in a way which is independent of the supply to the microgrid: power demand may be the only extrinsic electrical parameter which plays into the generator operating control.

If the output of the DC generator 104 rises without return of grid power, or if the draw of the critical loads 110 declines to the point where the critical loads can be supplied from the DC generator 110, then the excess available power from AC generator 102 is preferably used to “top up” the energy storage unit 106 before AC generator 102 is shut down.

The AC generator 102 is preferably operated for maximum efficiency. This is most simply achieved by constant-speed operation.

### 3-Port System Example

The serial hybrid microgrid converter can be used with 2-port, 3-port and up to n-port PPSA converters. One example of a serial hybrid microgrid uses a 3-port PPSA Hybrid Converter with two independent DC ports and one AC port. One DC port can be connected to an energy storage system, such as one or more batteries, and the second DC port can be switched between different generators with only one active at a time. A photovoltaic array (DC generator) is available to produce power during daylight hours, and a diesel generator (asynchronous AC generator) is used at night or during cloudy conditions. The energy storage system supplements output at times of peak power demand, and buffers the power from any of the generators.

The PPSA Power Converter provides grid-connected operation when an active power grid is available. During grid-faults or in remote applications when a power grid is not available, the disclosed converter acts as an island and provide grid-forming capabilities.

In some sample embodiments, the asynchronous generator and load AC can have different power specifications. For example, a 60 Hz generator can be used with a 50 Hz load for international needs.

### Example with 3-port Converter

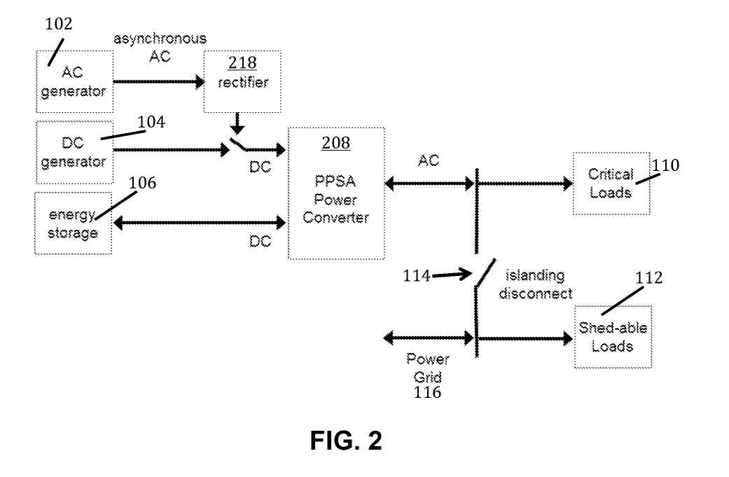

FIG. 2 shows a different implementation, which does not require a four-port converter. Elements which are the same as in FIG. 1 are given the same numbers. Here a grid connection 116 supplies sheddable loads 112, and is also routed through an islanding disconnect switch 114 to supply the microgrid which includes the critical loads 110. Also connected to this microgrid is a power-packet-switching converter, but this is a three-port converter 208 rather than the four-port converter 108 of FIG. 1. (Otherwise the two converters are nearly identical.)

The converter 208, in this example, is a three-port converter. One port is connected to the grid. A second port is connected to an asynchronous AC genset 102 (e.g. diesel-powered) through a rectifier element 218. A third port is connected to a DC energy storage unit 106, which can be e.g. a bank of batteries. A non-dispatchable power source 104, which can be solar, wind, or hydroelectric power, or cogeneration using waste heat.

The generator most preferably has no specific frequency, voltage, phase or power quality requirements. The generator can be optimized for efficiency independent of these parameters. It runs only at maximum efficiency to charge battery then shuts off.

Advantages

The disclosed innovations, in various embodiments, provide one or more of at least the following advantages. However, not all of these advantages result from every one of the innovations disclosed, and this list of advantages does not limit the various claimed inventions.
Improved efficiency in power conversion systems.
Better ground-fault protection in power conversion systems, with reduced likelihood of tripping ground-fault protection.
Allows an asynchronous AC generator to provide grid tied capabilities.
Allows the AC generator to operate at the optimum fuel to kW efficiency point.
Improved power quality including harmonics, power factor and unbalanced load support.
Enables a modular nano-grid power system and simplified control architecture.

According to some but not necessarily all embodiments, there is provided: A microgrid, comprising: a power-packet-switching power converter, having one port thereof connected to a microgrid power line; an engine-powered generator having a power output connected to a second port of the converter; and a non-dispatchable power source connected to a third port of the converter; wherein the engine-powered generator, when active, is allowed to vary the frequency of power at the second port over a range of at least 2% of its value, and is allowed to vary the voltage of the power output over a range of at least 10% of its value.

According to some but not necessarily all embodiments, there is provided: A microgrid, comprising: a power-packet-switching power converter, having one port thereof connected to a microgrid power line; an engine-powered generator having a power output connected to a second port of the converter; a non-dispatchable power source connected to a third port of the converter; and a battery bank operatively connected to the non-dispatchable power source and to the third port; wherein the engine-powered generator, when active, is allowed to vary the frequency of power at the second port over a range of at least 2% of its value, and is allowed to vary the voltage of the power output over a range of at least 10% of its value.

According to some but not necessarily all embodiments, there is provided: A microgrid, comprising: a power-packet-switching power converter, having one port thereof connected to a microgrid power line; an engine-powered generator having a power output connected to a second port of the converter; a non-dispatchable power source connected to a third port of the converter; and a battery bank operatively connected to the non-dispatchable power source and to the third port.

According to some but not necessarily all embodiments, there is provided: A method of operating a microgrid, comprising: supplying available power from a non-dispatched power source to one port of a power-packet-switching power converter, and converting voltage, frequency and/or phase to provide power at another port of the power-packet-switching power converter; starting an asynchronous AC generator, when needed, if the output of the non-dispatched power source is not sufficient to supply critical loads on the microgrid, and running the AC generator without regard to electrical parameters of the microgrid, other than power demand, and converting the voltage and/or frequency of the AC generator as may be needed; and buffering power flows using an energy storage component which is connected to another port of the converter.

According to some but not necessarily all embodiments, there is provided: A microgrid system in which power from a non-dispatchable energy source and power from a combustion-powered backup generator are both connected to the microgrid and its loads through a Power Packet Switching Architecture (PPSA) power converter. The converter provides voltage management and synchronization for both the backup generator power and also for the non-dispatchable power.

According to some but not necessarily all embodiments, there is provided: A method of operating a power-packet-switching power converter, comprising: connecting an asynchronous AC generator to one port of said power-packet switching power converter; controlling the output of said asynchronous AC generator to optimize operation of said asynchronous AC generator dependent on requested power; wherein said controlling step optimizes operation of said asynchronous AC generator independently of electrical criteria besides said requested.

According to some but not necessarily all embodiments, there is provided: A microgrid system in which power from a non-dispatchable energy source and power from a combustion-powered backup generator are both connected to the microgrid and its loads through a Power Packet Switching Architecture (PPSA) power converter. The converter provides voltage management and synchronization for both the backup generator power and also for the non-dispatchable power.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

For one example, the non-dispatchable power source can be wind, solar, or hydro power, or can be a cogeneration contribution from waste process heat.

For another example, this architecture can be implemented at many different scales. A large military base which draws many megawatts of grid power will have differently scaled components from the 100 kW backup for a small hospital, but either is a candidate for use of the disclosed architecture.

The optimization of AC generator operation can be done in many different ways. For example, engine operation can optimized with reference to:
engine efficiency;
genset efficiency;
CHP (combined heat power);
all-in cost per Joule;
total engine lifetime, measured in hours or in kilowatt-hours;
genset lifetime, measured in hours or in kilowatt-hours; or
all-in system cost (including challenge of low power quality to components).

It is also possible to introduce some dependence on instantaneous load, and to allow the optimized engine control to vary with load. At very low loads the most efficient operation may be to shut down generation, but operation when the load demand is near maximum, but not 100%, can help avoid frequent startups and shutdowns. (This is somewhat dependent on the size of the energy storage 106; if the storage 106 can supply full demand for three hours, then that limits the frequency of shutdowns.) Maximum efficiency can thus require a different rpm and/or different output voltage at 100% load than at 80%.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A microgrid, comprising:
a power-packet-switching power converter, having one port thereof connected to a microgrid power line;
an engine-powered generator having a power output connected to a second port of the converter; and
a non-dispatchable power source connected to a third port of the converter;
wherein the engine-powered generator, when active, is allowed to vary the frequency of power at the second port over a range of at least 2% of its value, and is allowed to vary the voltage of the power output over a range of at least 10% of its value.

2. The microgrid of claim 1, wherein the non-dispatchable power is photovoltaic power.

3. The microgrid of claim 1, wherein the non-dispatchable power is wind power.

4. The microgrid of claim 1, wherein the AC generator includes a diesel engine.

5. A microgrid, comprising:
a power-packet-switching power converter, having one port thereof connected to a microgrid power line;
an engine-powered generator having a power output connected to a second port of the converter;
a non-dispatchable power source connected to a third port of the converter; and
a battery bank operatively connected to the non-dispatchable power source and to the third port;
wherein the engine-powered generator, when active, is allowed to vary the frequency of power at the second port over a range of at least 2% of its value, and is allowed to vary the voltage of the power output over a range of at least 10% of its value.

6. The microgrid of claim 5, wherein the non-dispatchable power is photovoltaic power.

7. The microgrid of claim 5, wherein the non-dispatchable power is wind power.

8. The microgrid of claim 5, wherein the AC generator includes a diesel engine.

9. A microgrid, comprising:
a power-packet-switching power converter, having one port thereof connected to a microgrid power line;
an engine-powered generator having a power output connected to a second port of the converter;
a non-dispatchable power source connected to a third port of the converter; and
a battery bank operatively connected to the non-dispatchable power source and to the third port.

10. The microgrid of claim 9, wherein the non-dispatchable power is photovoltaic power.

11. The microgrid of claim 9, wherein the non-dispatchable power is wind power.

12. The microgrid of claim 9, wherein the AC generator includes a diesel engine.

13-20. (canceled)
